(19) United States
(12) Patent Application Publication
(10) Pub. No.: US 2008/0258863 A1
(43) Pub. Date: Oct. 23, 2008

(54) Method and a System for Proximity Evaluation

(75) Inventors: Koen Hendrik Johan Vrielink, Eindhoven (NL); Peter Lenoir, Eindhoven (NL); Robert Paul Koster, Eindhoven (NL); Franciscus Lucas Antonius Johannes Kamperman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,051

(22) PCT Filed: Sep. 20, 2005
(86) PCT No.: PCT/IB05/53085

§ 371 Date: Mar. 27, 2007

(30) Foreign Application Priority Data
Sep. 28, 2004 (EP) 04104717.6

(51) Int. Cl. G05B 19/00

(52) U.S. Cl. 340/5.2

(57) ABSTRACT

This invention relates to a method and a system for evaluating proximity. A reference object is moved such that it enters at least two different proximity areas of two different proximity indicators, whereby proximity indications are generated. The time difference between the indications is measured. If the time difference is within predefined range it is ascertained that the reference object is within a well defined area. Thus, the fact that the speed of movement of a physical object is significantly limited is used for obtaining reliable proximity evaluations.

### FIELD OF THE INVENTION

The present invention relates to a method and a system for proximity evaluation.

### BACKGROUND OF THE INVENTION

In many different applications there is a need for reliable proximity evaluations, in order to ensure that an object is within a particular area. Typical applications are disclosed in WO 2004/014037, where the time of flight of electromagnetic waves is used for distance measurements. However, such measurements are difficult to perform in many applications and require a lot of hardware.

### SUMMARY OF THE INVENTION

It is an object of the present invention to eliminate or at least alleviate the described problems.

This object is achieved by a method and a system arranged in accordance with the appended claims 1 and 14. Preferred embodiments are defined in the dependent claims.

The invention is based on an insight that a combination of an object that has to be physically moved between different indicators and the registering of physical flight time, i.e. the time it takes to move the object, serve as a basis for creating a natural indication of the maximum size of the area within which the object has to be in order to comply with appropriate limitations of that time. Also the required measurements are relatively easy to perform.

Thus, in accordance with one aspect thereof, the invention relates to a method for proximity evaluation, comprising the steps of:
generating a first indication, indicating that a reference object is within a proximity area of a first proximity indicator;
determining a first time corresponding to the occurrence of said first indication;
generating a second indication, indicating that the reference object is within a proximity area of a second proximity indicator;
determining a second time corresponding to said second indication;
determining a lapsed time as the time difference between the first and second times;
comparing the lapsed time with a time range; and
determining a state of proximity in dependence of whether the lapsed time is within the time range, wherein each one of said steps of generating an indication comprises the step of obtaining information about the reference object.

Referring to the above defined object of the invention, the use of at least two different indications and the time range provides for a solution that implies a physical movement of the object within an allowed area, which has a limitable size. For example, since there are natural physical limitation for how fast an object is able to travel, by choosing an appropriate upper limit of the time range, the size of the allowed area is limited accordingly. Consequently, the size of the allowed area is controllable by the user of the method. Thus, typically, for obtaining a particular proximity state, it has to be determined that the reference object has moved at least from one proximity area to another within a predefined time range, where the different proximity areas are associated with different proximity indicators. Typically, that state is a positive state that indicates that the object is located within some critical area. Within the scope of the invention, as claimed, a lower limit for movement of the object is zero, i.e. the first and second proximity areas are allowed to overlap such that the object is within the both proximity areas at the same time. On the other hand, for example, by ensuring that the proximity areas never overlap, or by properly choosing the lower limit of the time range, it will be possible to force the object to be moved in order to obtain a desired state of proximity.

Further, in accordance to another aspect thereof, the invention provides for a system for proximity evaluation, wherein the system comprises a manager, a reference object, a first proximity indicator, and a second proximity indicator, wherein the first and second proximity indicators comprise a first and a second communication unit. The first proximity indicator is arranged to provide, by means of said first communication unit, a proximity indication, indicating that the reference object is within a proximity area of the first proximity indicator. _The second proximity indicator is arranged to provide, by means of said second communication unit, a proximity indication, indicating that the reference object is within a proximity area of the first proximity indicator. The manager is arranged to:
obtain information about a first time associated with said first indication, and a second time associated with said second indication;
determine a lapsed time as the time difference between said first and second times;
comparing the lapsed time with a time range and determine a state of proximity, in dependence of whether the time difference is within the range.

It is to be noted that within the scope of the invention, there are several possibilities of arranging the manager. For example, it can be a stand alone unit that communicates with the proximity indicators for obtaining the necessary information, or it can be a part of one of the proximity indicators, or it can be a part of the reference object. In the latter case, for example, the proximity indications are transmitted from the proximity indicators to the reference object, where the computation takes place.

In accordance with embodiments of the method and the system, as defined in claims 3 and 18, respectively, the wireless technology of NFC is used. NFC (Near Field Communication) is a technology that provides very distinct limits for the proximity areas, since the range of the NFC communication units is in the order of magnitude of decimeters.

In accordance with embodiments of the method and the system of the invention as defined in claims 3 and 18, respectively, the communication technology is Bluetooth®. This is appropriate for some other applications than the NFC technology, as will be exemplified below.

In accordance with embodiments of the method and the system of the invention as defined in claims 2 and 15, respectively, the proximity area is equal to a coverage of a communication unit used for the obtainment of information. Thereby the size of the proximity area is well-defined.

In accordance with embodiments of the method and the system of the invention, as defined in claims 4 and 20, respectively, biometrics are used. For example, this technology enables direct detection of human beings.

In accordance with embodiments of the method and the system of the invention, as defined in claims 5 and 20, respectively, the object is actually moved between the first and second indications. This is a common case.

In accordance with an embodiment of the method, as defined in claim 6, a user of the reference object is forced to move the object, which is useful for applications where it is of interest to ascertain that the indicators are located at a certain distance from each other.

An embodiment of the method, as defined in claims 7 and 8, is particularly useful for applications having a central manager, which is also occupied with other tasks that require a computational capacity.

This is the case in an embodiment of the system as defined in claim 16, where the manager is a central resource used by all proximity indicators. One application, among many, is Authorised Domain Systems.

Embodiments of the method and the system of the invention, as defined in claims 9 and 21, respectively, provide for the use of a reasonable estimation of the lapsed time on basis of the distance between the coverage areas of the different proximity indicators.

An embodiment of the method as defined in claim 10 focuses on applications involving an authentication procedure. Typical applications are related to secure access to information.

An embodiment of the method as defined in claim 11 is advantageous in applications where it is determined less frequently if an object is still within an area. In accordance with an embodiment of the method as defined in claim 13, the indicators communicate with each other in order to enable one thereof to perform the steps, which uses the times. This is a decentralized way of performing the method.

These and other aspects of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 is a schematic block diagram, showing an embodiment of the system according to the present invention as applied to an Authorised Domain;

FIGS. 2-6 are schematic block diagrams showing further system embodiments.

### DESCRIPTION OF PREFERRED EMBODIMENTS

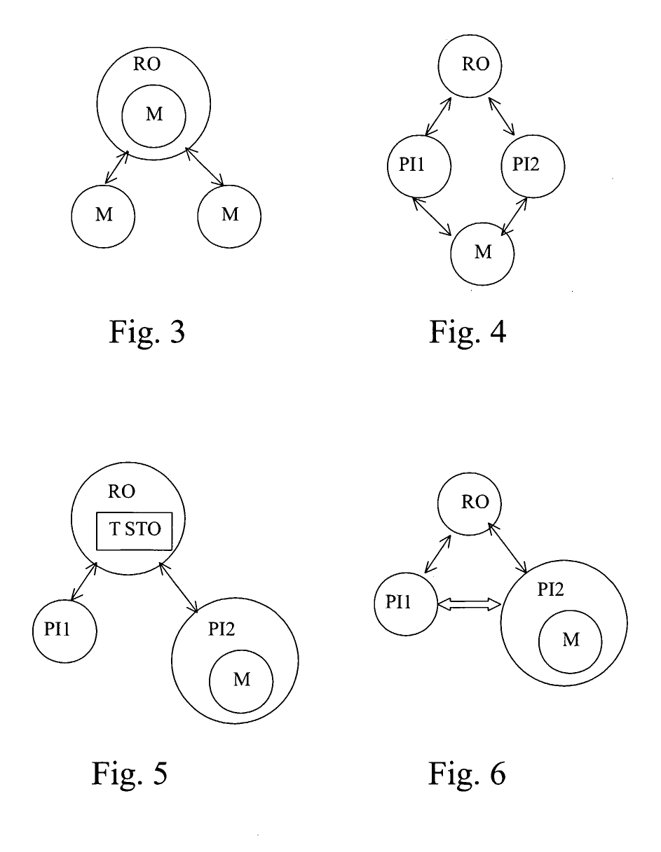

An exemplifying embodiment of the present invention is applied for an Authorised Domain (AD), as shown in FIG. 1. An AD is a number of devices that together form a network, which is delimited in its extension and wherein every new device has to be approved in order to be added to the AD. In some architectures, one or more of the devices has the function of an ADM, i.e. AD Manager, that is able to admit or refuse new devices. In other architectures management functionality is handled in a distributed fashion.

Some particular architectures of authorized domains have been outlined in international patent application WO 03/098931 (attorney docket PHNL020455), European patent application serial number 03100772.7 (attorney docket PHNL030283), European patent application serial number 03102281.7 (attorney docket PHNL030926), European patent application serial number 04100997.8 (attorney docket PHNL040288) and F. Kamperman and W. Jonker, P. Lenoir, and B. vd Heuvel, Secure content management in authorized domains, Proc. IBC2002, pages 467-475, September 2002. Authorized domains need to address issues such as authorized domain identification, device check-in, device check-out, rights check-in, rights check-out, content check-in, content check-out, as well as domain management.

Typically, an AD has a limited geometrical extension, such as a home. Thus, in order to admit a new device as a member of the AD, it is possible to apply a proximity criterion as one of the criteria that the new device has to fulfil in order to be added to the AD.

In accordance with this embodiment, a first device D1, which is to be added to the AD, is connected to the AD network. Then the ADM discovers D1 and checks which criteria that has to be fulfilled in order to add D1 to the AD. These criteria are a) D1 is compliant; b) a maximum size of the AD is not reached, for instance the number of devices in the AD is less than a predetermined number; and c) a proximity status is acknowledged. The ADM then checks that criteria b) is fulfilled; sets up a Secure Authenticated Channel to D1, in order to verify compliance of D1; and starts evaluating the proximity criteria. The proximity criteria renders the following steps:

1) The ADM sets up a second Secure Authenticated Channel to a second device D2, which is already a member of the AD.

2) The ADM prompts the user of D1 to use a reference object RO for proximity measurements to tap the first device D1 and then the second device D2, in that order. Here, D1 is used as a first proximity indicator, and D2 is used as a second proximity indicator.

3) The user taps D1 with RO. As shown in FIG. 1 RO is within the proximity area of D1, as indicated by the dashed line of the large circle. D2 has a corresponding proximity area that RO will enter at a later stage, as indicated by the dash-dotted circle encircling RO.

4) D1 generates a first proximity indication, indicating that the reference object RO is within its proximity area, determines a first time, corresponding to the occurrence of the proximity indication, and sends the first time to the ADM.

5) The user carries the reference object to D2 and taps D2 with the reference object.

6) D2 performs the corresponding steps as D1, thus sending a second time to the ADM.

7) The ADM determines a lapsed time as the time difference between the first and second times, compares the time difference with a time range, and determines a state of proximity in dependence of whether the time difference is within the range.

8) If the time difference is within the range, the state is set positive, and then the ADM adds the new device D1 to the AD. If the time difference is outside of the range, then the state is set negative and the ADM refuses the new device D1.

This embodiment of the method corresponds to a specific arrangement of some hardware and software resources at the different devices involved.

Thus, a corresponding embodiment of a system for carrying out the method comprises the Authorised Domain AD, the first device D1, and the reference object RO. The AD at least has the ADM and the device D2 that is a member of the AD. The ADM, generally, can be seen as a management function or resource, which can be realised by means of a separate, dedicated, device, or invoked in any, or every, device of the AD. Consequently, for example, D2 could be provided with the ADM function. However, in this embodiment, the ADM resides in some other device within the AD. The ADM and the devices D1, D2 each have a processing unit for handling computational and control operations. Further, the devices D1, D2 each have a communication unit C1, C2 for communicating with the reference object RO, which also has a communication unit C3.

D1 and D2, communicate with RO by means of Near Field Communication (NFC) technology. Thereby the communication units C1-C3 have to be within one or a few decimetres, typically less than 0.2 m, of each other in order to be able to establish contact. This coverage defines the proximity area of each device D1, D2. NFC enables a secure detection of RO, and, thus, a secure proximity indication that is reliably useful for the devices D1, D2, and for the ADM.

The short range communication of NFC has inspired to the use of the term “tap”, which for the purposes of this application is to be interpreted as moving the reference object into the proximity area of a proximity indicator, e.g. the first and second devices D1, D2, so that the proximity indicator is able to generate a proximity indication. When it comes to NFC, the range is so short that, in fact, the reference object often briefly gets into contact with (taps, in a more common sense) the proximity indicator.

There are many alternative embodiments of the method as well as the system within the field of AD as well as in other fields. Some examples are given below.

According to an alternative embodiment, the reference object does not have an active communication unit, but merely a passive one, that “echoes” a response when hit by the radio signal from a proximity indicator. This makes it possible to provide a very simple structure of the reference object. On the other hand, in an alternative embodiment, as shown in FIG. 3, the reference object is provided with the full capability of both detecting proximity to other devices, making time measurements and executing the further steps that results in the state of proximity.

According to an alternative embodiment the user of the reference object is not actively prompted to move, but instead the proximity indicators generate proximity indications whenever the reference object comes within the proximity areas thereof. Thus, once in a while a proximity indication is generated. For example, this embodiment is useful when it is of interest to track a user of a reference object. In this embodiment a medium range communication technology providing a range in the order of several meters, such as Bluetooth®, is suitable.

While the reference object typically is an electronic device, such as an RFID (Radio Frequency Identification) tag, a smartcard, or a mobile phone, there is also room for using the very user, i.e. a human being, as a reference object, conditioned by the use of biometric detectors as proximity indicators. Thus, while many different communication technologies are useful, short range ones, like the wireless technologies of NFC or even contact based ones, like the smartcard or a USB-dongle are preferable in order to have a well defined limit of the proximity area. Here it is to be noted that in case the reference object is managing the computational operations the range of the proximity area can be defined by the communication unit of the reference object rather than by communication units of the proximity indicators.

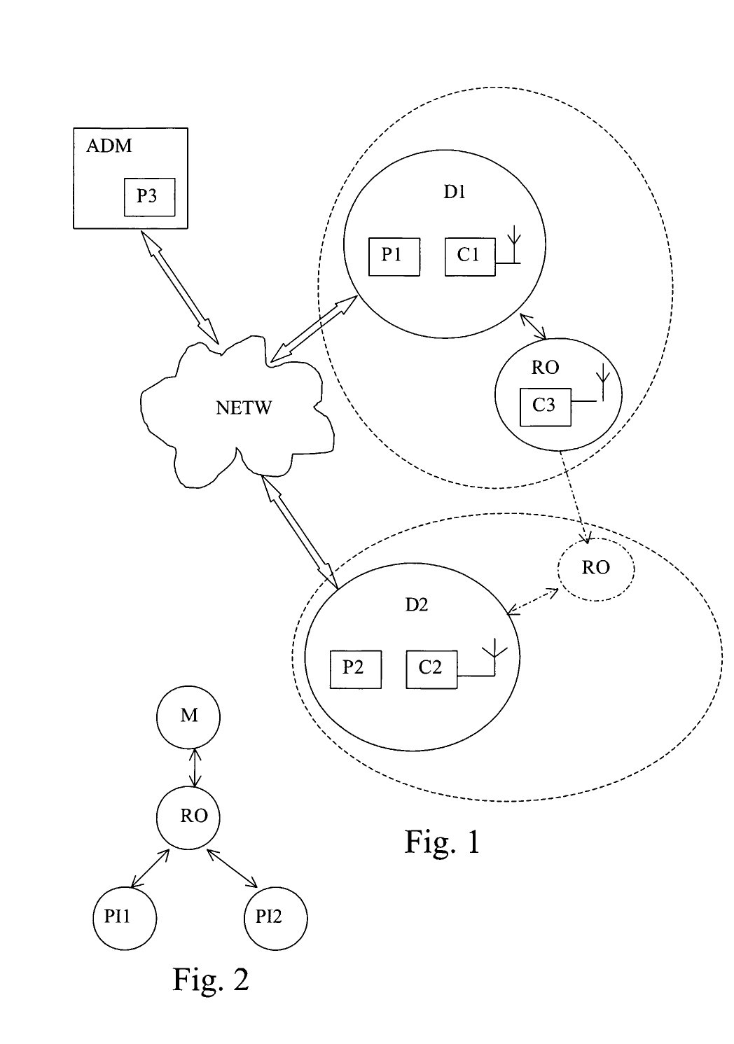

In an alternative embodiment the reference object measures and stores the lapsed time, which is then retrieved by the manager, as shown in FIG. 2.

In yet another embodiment, as shown in FIG. 5, the first time is determined by the first proximity indicator and stored in a storage (T STO) of the reference object. Then the second proximity indicator, which also has the manager capabilities, retrieves the first time from the storage and performs the determinations of the lapsed time, etc.

Thus, as explained by means of the embodiments above, a reference object is moved such that it enters at least two different proximity areas of two different proximity indicators, whereby proximity indications are generated. The time difference between the indications is measured. If the time difference is within predefined range it is ascertained that the reference object is within a well defined area. Thus, the fact that the speed of movement of a physical object is significantly limited is used for obtaining reliable proximity evaluations.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1-23. (canceled)

24. An authorized domain system configured for proximity evaluation of a first device to be admitted into the authorized domain, wherein the system comprises an authorized domain manager, a reference object, a first proximity indicator comprised in the first device, and a second proximity indicator comprised in a second device, wherein the first and second proximity indicators comprise a first and a second communication unit, respectively, and wherein:
said first proximity indicator is arranged to provide, by means of said first communication unit, a proximity indication, indicating that the reference object is within a proximity area of the first proximity indicator; and
said second proximity indicator is arranged to provide, by means of said second communication unit, a proximity indication, indicating that the reference object is within a proximity area of the first proximity indicator; and wherein said authorized domain manager is arranged to:
derive a first time from said first indication, and a second time from said second indication;
determine a lapsed time as the time difference between said first and second times; and
compare the lapsed time with a time range and admitting the first device into the authorized domain, in dependence of whether the time difference is within the time range.

25. The system according to claim 24, wherein said proximity areas are defined by a coverage of a respective one of said first and second communication units.

26. The system according to claim 24, wherein said manager is a separate device, which is connected with said proximity indicators.

27. The system according to claim 24, wherein the reference object comprises a communication unit.

28. The system according to claim 24, wherein said communication units uses one of NFC and Bluetooth® technology.

29. The system according to claim 24, wherein said first and second communication units use biometrics.

30. The system according to claim 24, wherein said reference object is arranged to be moved a distance in the meantime between said first and second indications.

31. The system according to claim 24, wherein the size of the time range is related to the size of the proximity areas.
